(19) United States
(12) Patent Application Publication
(10) Pub. No.: US 2003/0172028 A1
(43) Pub. Date: Sep. 11, 2003

(54) Authorization of payment for a commercial transaction via a bluetooth enabled device

(75) Inventors: Jonathan Alan Abell, Jacksonville, NC (US); Jamel Pleasant Lynch II, Chapel Hill, NC (US); Charles Burhnam Oxrieder, Raleigh, NC (US); Usen E. Udoh, Durham, NC (US); William John Vigilante JR., Raleigh, NC (US)

Correspondence Address: IBM CORPORATION, IP Law Dept., Dept. 9CCA/002, P.O. Box 12195, Research Triangle Park, NC, 27709-2195, US

(73) Assignee: International Business Machines Corporation, Armonk, NY

(21) Appl. No.: 10/093,173

(22) Filed: Mar. 7, 2002

(51) Int. Cl. G06F 17/60

(52) U.S. Cl. 705/40

(57) ABSTRACT

A personal payment system that enables a desired items to be purchased by the customer utilizing a wireless enabled device such as a cellular phone, PDA, etc. The system comprises a background structure that enables electronic payment transactions, a terminal linked to the background structure having wireless interactive capabilities, and a customer device with wireless capabilities that enables the customer to remotely interact with the terminal and authorize payment for a financial transaction within the background structure. The wireless transmission features of the invention are implemented via Bluetooth protocol.

### BACKGROUND OF THE INVENTION

1. Technical Field

The present invention relates generally to wireless devices and in particular to Bluetooth enabled devices. Still more particularly, the present invention relates to a method and system for authorizing payment of a financial transaction via a Bluetooth enabled device.

2. Description of the Related Art

Wireless technology now reaches or is capable of reaching virtually every location on the face of the earth. With the growing desire for greater mobility, flexibility, and improved features in wireless hand held or mobile devices, the computer and communications industry are continually finding ways to expand the functionality of these devices. The most recent development in the field of wireless technology is Bluetooth, which provides the specification for short distance wireless radio frequency (RF) communication applications. Bluetooth operates in a multi-user environment to allow wireless communication between a cellular phone, a computer, and other personal electronic devices within a specific radius of each other.

Bluetooth has quickly gained support throughout the wireless industry for its potential in providing personal area networks (PANs) and its capabilities of linking multiple devices together. For example, Bluetooth has simplified the process of interconnecting cellular phones, computers, PDAs, printers and a number of other electronic devices. Further, Bluetooth enabled devices are also being produced, frequency hopping techniques that enable communication to continue flowing even in “noisy” areas.

With the infrastructure in place to seamlessly connect multiple mobile devices and the capability of a user to create a PAN with a single portable device, the extension of Bluetooth capabilities to other everyday usage is expected to be the next stage of development.

One such everyday usage involves personal financial transactions. For example a customer in a restaurant purchasing a meal has to pay for the service. Traditionally, such a transaction involves the customer waiting on a bill, providing the waiter with payment tender (cash or credit card), waiting for the waiter to go to the cash register and ring up the sale, and then waiting for the waiter to return with the change or the signature slip for the credit card. Notably, current trends in personal financial transactions is moving towards elimination of direct cash transactions and payment via credit cards, which involves a background authorization transaction. Also, most customers today have a mobile device, e.g., a cellular phone, a PDA, etc. most of which may be designed to provide wireless transmission via Bluetooth protocol.

The present invention recognizes that a more efficient method may be provided to complete in person financial transactions. A method and system that reduces the wait time for completion of everyday personal financial transactions would be a welcomed improvement. It would be further desirable if a customer is able to authorize payment for a financial transaction with any mobile device so that the customer does not have to necessarily require a special card or device to complete the transaction. These and other benefits are provided by the invention described herein.

### SUMMARY OF THE INVENTION

Disclosed is a personal payment system that enables a desired item to be purchased for by the customer utilizing a wireless enabled device such as a cellular phone, PDA, etc. The system comprises a background structure that enables electronic payment transactions, a terminal linked to the background structure having wireless interactive capabilities, and a customer device with wireless capabilities that enables the customer to remotely interact with the terminal and authorize payment for a financial transaction within the background structure.

The background structure includes a server associated with the terminal and a payment authorization system that is connected to the server and that provides payment upon receipt of a confirmed request from the server. The payment authorization system receives a request for payment of a transaction from the server, verifies that the payment is authorized by the customer, who is affiliated with the payment authorization system via an agreement and unique ID, and electronically issues the payment to a financial institution indicated by the server.

In one embodiment, the server is connected to the payment authorization system via a wide area network (WAN), such as the Internet, although the two components may be connected via a local area network (LAN). Also, the payment authorization system is a customer registered service with which the customer has a service contract and all confirmed payments are placed on a bill issued to the customer. The customer registered service may be a credit card authorization system, for example. However, in one embodiment, the payment authorization system is an electronic pre-payment system that allows the customer to set up an online account that allows payment to requesting servers with customer authorization. customer-portable device comprises wireless communication capabilities and a payment request algorithm that together provide a wireless transmission of a payment request, which includes a unique customer ID and network address information of a payment authorization service, in response to an input by the customer. For security purposes, a special code may also be required prior to transmitting the payment request.

The terminal receives a wireless transmission of the request to complete the payment transaction from the customer, and in response to an initial receipt of the wireless transmission, the terminal immediately forwards the request along with a dollar amount for the transaction to the background structure. In one embodiment, the terminal comprises a memory component in which it stores data from an initial transaction. When the next transaction from the customer is received (identified by comparing the stored data with data from the current request), the terminal checks its memory for approval of the customer and then automatically permits the next transaction without requiring authorization from the payment authorization system. The terminal may then send the next transaction to the payment authorization system for payment at a later time.

In one illustrative embodiment of the invention, the terminal is a component of a vending machine that provides the customer with an item selected by the customer. The item is provided upon receipt of a signal from the background structure that indicates the financial transaction is approved.

In another illustrative embodiment, the terminal is a cash register that rings up an amount after completion of a purchase by the customer. One extension of this embodiment allows the customer to scan, via the wireless device, the bar code from a bill generated for the transaction. The identifying information (associated with the bar code) is then included with the information submitted to the background structure.

Notably, the wireless transmission features of the invention is implemented via Bluetooth protocol. Utilizing Bluetooth protocol, the customer device creates a personal area network (PAN) connecting the customer device with the terminal and, in certain embodiments, also connecting the server.

All objects, features, and advantages of the present invention will become apparent in the following detailed written description.

### DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 illustrates a system diagram of a basic network communication system employing the Bluetooth protocol within which one embodiment of the present invention may be implemented;

FIG. 2 is a block diagram representation of a system within which remote payment authorization and bill payment features may be implemented according to one embodiment of the invention;

FIG. 3 is a block diagram representation of a terminal with wireless capabilities coupled to a background structure to enable the remote payment features of the present invention;

FIG. 4 is a block diagram representation of a Bluetooth enabled customer device with which a customer initiates remote payment transactions according to one embodiment of the present invention;

FIG. 5 is a flow chart illustrating the processing which occurs at the customer side during operation of the remote payment process of the invention;

FIG. 6 is a flow chart illustrating the processing which occurs at the terminal side during operation of the remote payment authorization process of the invention; and

FIG. 7 is a block diagram illustrating the application of the features of the invention to a vending machine transaction according to one embodiment of the invention.

### DESCRIPTION OF AN ILLUSTRATIVE EMBODIMENT

The present invention may be implemented in a variety of different network configurations that provide short range wireless radio frequency (RF) transmissions. The illustrative embodiment of the invention is however presented with specific reference to a network implementing Bluetooth protocol. This is however not meant to be limiting on the invention. Additionally, specific terminal and customer device configurations are illustrated and described herein. As with the network, these specific representations are made for illustrative purposes only and not meant to be limiting on the invention.

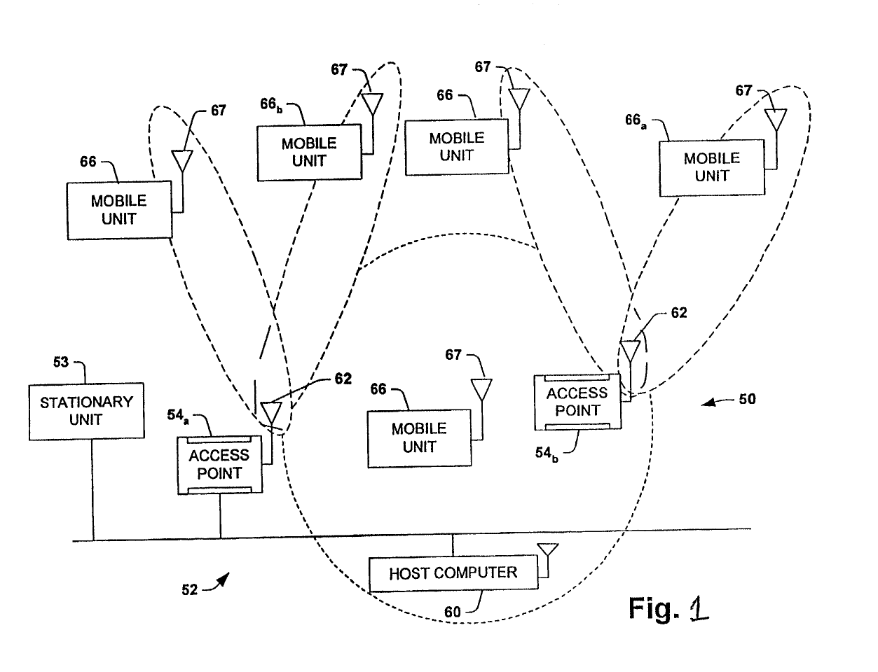

Referring now to the figures, and in particular to FIG. 1, there is illustrated a cellular communication system 50, which operates via the Bluetooth standard/protocol. The cellular communication system 50 includes a local area s network (LAN) 52. The LAN or network backbone 52 may be a hardwired data communication path made of twisted pair cable, shielded coaxial cable, or fiber optic cable, for example, or may be wireless or partially wireless in nature. Coupled to the LAN 52 are a stationary communication unit 53 and several access points 54. The access points 54 may be hardwired to the network 52 such as access point 54a or may be wirelessly coupled to the backbone 52 such as access point 54b. Only one access point 54a is shown hardwired to the network backbone 52, however, it is understood that more than one hardwired access points may be physically connected to the network backbone 52. Each access point serves as an entrance point through which wireless communications may occur with the network backbone 52. The wireless access point 54b may be employed to expand the effective communication range of the cellular communication system 50. As in conventional systems, each wireless access point 54b associates itself, typically by registration, with another access point or a host computer 60 coupled to the network backbone 52, whether hardwired or wireless, such that a link is formed between itself and other devices situated on the network backbone 52.

Each access point 54 is capable of wirelessly communicating with other devices in the communication system 50 via respective antennas commonly denoted by reference numeral 62. A geographic cell (not shown) associated with each access point 54 defines a region of coverage in which successful wireless communication may occur.

The cellular communication system 50 also includes one or more mobile communication units 66. The mobile communication units 66 each include an antenna 67 for wirelessly communicating with other devices. For example, the antenna 67 could be a directed disconnect type antenna for a more directed vertical electrical field over a ground plane. In the illustrative embodiments, wireless communication within system 50 occurs via Bluetooth protocol and each mobile communication unit 66 and access point 54 is configured according to Bluetooth specification.

Each mobile communication unit 66 communicates with devices on the network backbone 52 via a selected access point 54 and/or with other mobile communication units, and/or directly with the host computer 60, if within cell range of the host computer 60. Upon roaming from one cellular to another, the mobile communication unit 66 is configured to associate itself with a new access point 54 or directly with the host computer 60 if within range. A mobile communication unit 66 registers with a particular access point which provides the particular mobile communications unit with wireless access to the network backbone 52. Typically, access points 54 and mobile units 66 in different cells can communicate with each during the same time period, such that simultaneous communication occurs in system 50.

The present invention extends the functional features of Bluetooth technology to provide a method and system that enables wireless authorization of payment for products and/or services. The invention requires the customer to first establish a service contract such as a Wireless Cellular agreement or credit card agreement, approving the utilization of the service contract for additional authorized billing, and later utilizing the service contracts as an agreed billing mechanism to pay for services and/or products received. The illustrative embodiments of the invention are described with reference to specific type of purchases and assumes that the terminals provided for payment of these purchases are enabled to receive (and in some cases transmit) wireless communication.

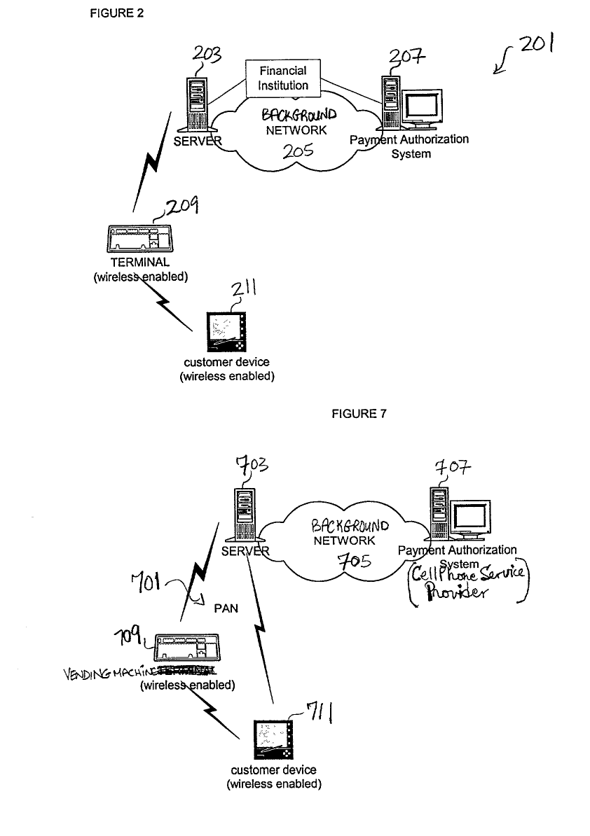

FIG. 2 illustrates one embodiment of a network 201 by which the features of the present invention may be implemented. Network (or system) 201 comprises background (or transparent) components and customer accessible components. Background components include a server 203 associated with the retailer or provider of the service or product being purchased and a payment authorization system 207. Payment authorization system 207 is connected to server 203 via a background network 205. Background network 205 may be a wide area network (WAN), such as the Internet, or a local area network (LAN). Communication between server 203 and payment authorization system 207 is initiated utilizing respective IP or network addresses depending on the characteristics of the background network 205 is being utilized (i.e., type of communication protocol being used).

Payment authorization service 207 may be a financial service, such as a credit card authorization service. However, the invention contemplates utilization of basic contracting entities such as a cellular phone provider that issues periodic bills to a subscriber. Alternatively, payment authorization service 207 may be an established online fund account, which the customer pre-pays into and is provided an electronic account (e.g., e-funds) with a usable balance. Notably, payment authorization system 207 may comprise any number of subsystems that operate together to provide authorization to server 203 to bill for a requested service or product to a particular customer. In one embodiment, the customer is required to enable or select an option, which implements such payments prior to actually utilizing the customer account in this manner.

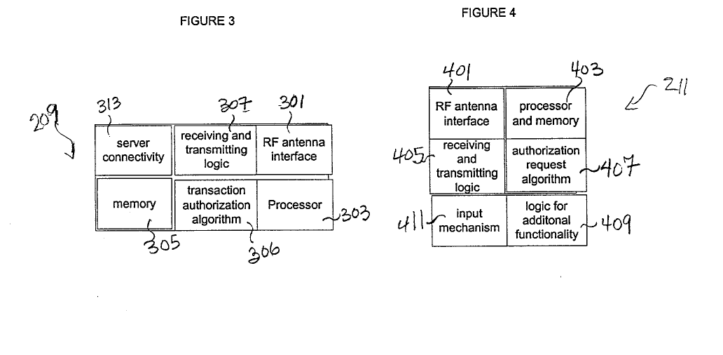

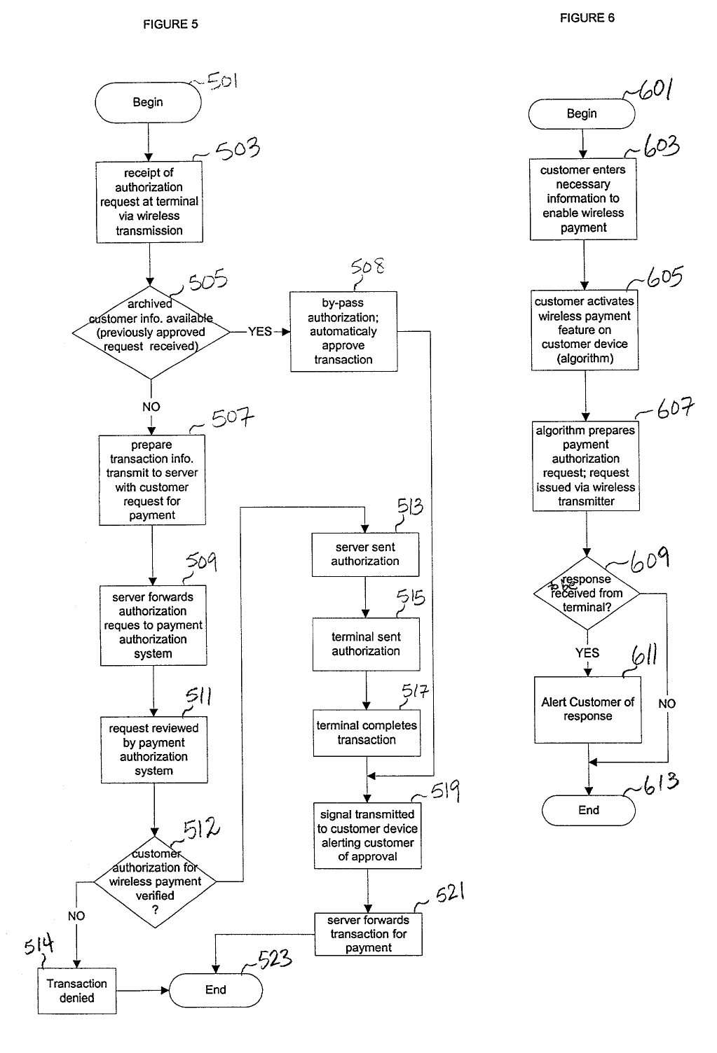

The customer accessible components of network 201 includes terminal 209 affiliated with server 203 and customer-portable, wireless enabled device 211. Terminal 209 may be a part of a larger component, such as a vending machine, as described below, or may be a cash register or similar device. FIG. 3 illustrates a block diagram of representative sub-components of terminal 209. As illustrated, terminal comprises wireless (or RF) antenna interface 301, processor 303, and memory 305. Executing on processor 303, is a wireless authorization algorithm (processor code) 306 that, responsive to a receipt of an activation signal, implements the processes described below and illustrated in FIG. 5. In the illustrative embodiment, terminal also comprises a receiving and transmitting logic 307 by which it communicates information to and from customer-portable wireless device 211 via antenna interface 301 and server connectivity 313. Server connectivity 313 enables terminal 209 to connect with server 203. Terminal 209 may be directly connected to server 203 or connected to server 203 via an internal network (e.g., LAN) or via a wireless connection (e.g., Bluetooth). When connected via wireless connection, wireless receiver 301 and transmitter 307 are further utilized to communicate with server 203.

As illustrated in FIG. 4, customer-portable wireless device 211 comprises processor and memory 403, wireless (or RF) antenna interface 401, receiving and transmitting logic 403, and an input mechanism 411. Additionally, customer-portable, wireless device 211 includes an authorization request algorithm 407. Authorization request algorithm 407 comprises program code by which necessary information to complete a payment authorization request is placed in a transmission packet and prepared for transmission. The necessary information may include customer entered information, and the input mechanism 411 is utilized to permit the customer to enter the required data/information to set up authorization request algorithm 407, and to initiate generation of the request and subsequent transmission via the antenna interface 401. Customer-portable, wireless device 211 may be a cellular phone, a personal digital assistant (PDA), such as a Palm Pilot™, a laptop computer, or a Bluetooth device. Customer-portable, wireless device 211 is capable of transmitting and receiving RF signals/communications. Preferably, the customer-portable, wireless device 211 supports Bluetooth protocol and communicates according to Bluetooth protocol. Also, terminal 209 preferably supports and communicates via the Bluetooth protocol.

The invention finds particular applicability within a merchant environment. Thus, the invention provides a merchant system that is enabled with a server and/or terminal that supports the Bluetooth payment method. The customer has a Bluetooth-enabled device, similar to a cellular phone or computer, and is thus able to link to the merchant's server or backend infrastructure and provide the customer's Bluetooth identifying (ID) information and an authorization to bill a particular service contract of the customer.

FIG. 5 illustrates the backend process by which the bill payment via a Bluetooth enabled device is implemented. The process begins at block 501, and proceeds to block 503, which illustrates the wireless receipt of an authorization request at the Bluetooth enabled terminal. The request includes the customer ID and address identification of the payment authorization system to be utilized (e.g., by IP or network address). Depending on the nature of the transaction, the authorization request may be accompanied by information about the transaction for which payment is to be made. A determination is made at block 505 whether a previous request by the same customer has been archived. When no archived request exists for the customer, the terminal then compiles data about the transaction, if required, and transmits the compiled data and request to the server as shown at block 507. Communication between the terminal and the server may be via a wired or wireless method, as described above. The server reads the address of the payment authorization system and forwards the request to the appropriate system as shown at block 509. Possible connection mechanisms between the server and the payment authorization system is described above. The payment authorization system reviews the request as shown at block 511 and verifies/determines that the customer is able to complete such a transaction within the service agreement as shown at block 512. If the customer is approved for such transactions, the payment authorization system informs the server of the approval as indicated at block 513. The server in turn signals the terminal of the approval as shown at block 515, and the terminal completes the transaction as indicated at block 517. The terminal may notify the customer of the approval by issuing a wireless signal to the customer's device as shown at block 519. In another embodiment, the terminal's completion of the transaction entails providing the customer with the requested service or product. When the customer is not approved for such transactions, the authorization request is denied as shown at block 514, and the process ends at block 523. Of course, alternate embodiments may require the customer be signaled with the denial message.

Returning to block 505, when a previous request is found in terminal memory (or in another embodiment, within server memory) the transaction is automatically approved using the previous approval information as shown at block 508, and the process of requesting authorization, etc., is bypassed. The server then forwards the transaction for electronic payment from the payment authorization system as shown at block 521. The process then ends as indicated at block 523. The payment authorization system makes a record of the payment and later bills the customer for the transaction.

FIG. 6 provides a flow chart of the payment authorization process from the customer device side. The process begins at block 601, and thereafter proceeds to block 603, which indicates a customer entering necessary information (e.g., customer ID, address information of payment authorization systems, password—if required, etc.) to enable wireless transfer of authorization data.

Entry of information may entail two actions: first, entering information to set up the payment authorization system (e.g., linking to a server affiliated with the service contract and choosing the payment option) to later authorize payments and bill the customer via a regular billing method and; second, entering information into the customer-portable device when setting up a request authorization algorithm installed on the customer-portable device. The second set of information may be entered in response to prompts received during installation/set up of the algorithm, and may include a customer ID known by the payment authorization system and a security code or password. The security code ensures that in the event of the loss or theft of the customer device, another unauthorized person is not able to utilize the customer device to make payments.

Returning now to FIG. 6, when a customer desires to make a payment utilizing the customer device, the customer selects the payment mode feature on the customer device and enters his security code to activate the algorithm as shown at block 605. The algorithm generates a packet with necessary information and issues the packet out via a wireless transmitter as indicated at block 607. When the terminal, which receives the authorization request, is programmed to provide a confirmation of approval, and that confirmation is to be received by the customer terminal as indicated at block 609, the customer is alerted upon receipt of the approval (or rejection) as shown at block 611. The process then ends as shown at block 613.

One application of the invention involves utilization of the Bluetooth payment authorization method with vending machines as illustrated in FIG. 7. The vending machine 709 is provided with a Bluetooth receiver and transmitter (i.e., communication logic and RF antenna) that transmits requests to an associated server 703. A transaction with the vending machine 709 may thus be completed via any Bluetooth enabled device 711, such as a PDA or cellular phone. With a cellular phone, for example, the customer calls the number on the vending machine (e.g., 1-800- . . . ). The call is connected to a background system including server 703 that is capable of initiating billing authorization request to the cellular phone contract provider 707. The customer's Bluetooth ID number is transferred to the background infrastructure (e.g., a server). The Bluetooth enable cellular phone 711 and associated customer ID is detected by the vending machine 709 via a Bluetooth link, and selection of a product from the vending machine is granted.

From the vending machine perspective, the request is received via Bluetooth transmission. The vending machine is provided with Bluetooth information from the infrastructure. The vending machine thus establishes a personal area network (PAN) 701 with the approved customer device 711 and dispenses product and forwards information about the items select to the infrastructure for payment processing.

Likewise, the customer utilizes the local network to establish a personal area network (PAN) 701 utilizing Bluetooth protocol. In the preferred embodiment, once the PAN 701 is established, successive visits by the customer may not require the customer link initiation via the local network.

Another illustrative embodiment involves the utilization of Bluetooth functionality by a customer to authorize payment for the customer's restaurant bill. The customer's mobile device (e.g., PDA, cellular phone, smartcard or other Bluetooth enabled devices) connects (wirelessly) to the restaurant's Bluetooth enabled billing system. The customer may scan a barcode on the bill, or enter a code number from the bill/receipt into the Bluetooth enabled device so that the restaurant's computer (e.g., cashier's register/terminal) is able to identify the customer and the bill is charged to the customer's account accordingly. Those skilled in the art appreciate that this process may be extended to similar service providing entities. Thus, with other service organizations, simple connection to proximity billing equipment would allow patrons, waitress, hosts, and service employees to offer a wireless connection to customers for ease of billing authorization.

One obvious benefit of this process is that the customer does not have to wait for the waiter or waitress to return with the customer's credit card, charge slip, and/or change. Further, the invention allows multiple streams of near simultaneous billing/authorization rather than individualized bill generation and signature authorization processing.

As a final matter, it is important that while an illustrative embodiment of the present invention has been, and will continue to be, described in the context of a fully functional data processing system, those skilled in the art will appreciate that the software aspects of an illustrative embodiment of the present invention are capable of being distributed as a program product in a variety of forms, and that an illustrative embodiment of the present invention applies equally regardless of the particular type of signal bearing medium used to actually carry out the distribution. Examples of signal bearing media include recordable media such as floppy disks, hard disk drives, CD-ROMs, and transmission media such as digital and analog communication links.

Although the invention has been described with reference to specific embodiments, this description should not be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A system for providing efficient payment of personal financial transactions comprising:
a background structure that enables electronic payment transactions;
a terminal linked to said background structure that supports wireless communication;
means for a customer device to wirelessly interact with said terminal and authorize payment for a financial transaction within said background structure.

2. The system of claim 1, wherein said background structure includes a server associated with a provider of a commercial product, and said terminal facilitates receipt of a payment for said product.

3. The system of claim 2, wherein said background structure further includes a payment authorization system that is connected to said server and that provides payment upon receipt of an authorized request from said server.

4. The system of claim 3, wherein said payment authorization system comprises:
means for receiving a request for payment of a transaction from said server;
means for verifying that said payment is authorized by a customer affiliated with said payment authorization system; and
means for electronically issuing said payment to a financial institution indicated by said server.

5. The system of claim 4, wherein said server is connected to said payment authorization system via a wide area network.

6. The system of claim 3, wherein said payment authorization system comprises a customer contracting service having a service contract with said customer, whereby said authorized payment is placed on a bill issued to said customer.

7. The system of claim 6, wherein said customer contracting service includes a credit card authorization system.

8. The system of claim 3, wherein said payment authorization system is an electronic pre-payment system to which said customer is associated.

9. The system of claim 1, wherein said customer device is a customer-portable device that supports wireless communication.

10. The system of claim 9, wherein said customer-portable device comprises payment request algorithm that generates a payment request that is wirelessly transmitted, wherein said payment request includes transaction data, a customer identifier (ID) and network address information of the payment authorization system, wherein said payment request is generated responsive to a customer input.

11. The system of claim 10, wherein said terminal receives a wireless transmission of said payment request to complete a payment transaction from said customer, wherein, responsive to an initial receipt of said wireless transmission, said terminal immediately forwards said payment request along with cost for said transaction to said background structure.

12. The system of claim 11, wherein said terminal further comprises:
a memory component;
means for storing customer authorization data from an initial transaction within said memory component; and
means, responsive to a receipt of a next payment request from said customer identified by said customer ID for automatically authorizing said next transaction and directly sending data of said next transaction to said payment authorization system for payment, whereby delay time in seeking authorization for a previously authorized customer is substantially eliminated.

13. The system of claim 12, wherein said terminal is a component of a vending machine that provides said customer with an item selected by said customer upon receipt of a signal from said background structure that indicates that said payment request is approved.

14. The system of claim 12, wherein said terminal is a cash register that calculates and provides said cost after completion of a purchase by said customer.

15. The system of claim 14, wherein said cash register issues a bill with a bar code identifying said transaction, wherein said customer device includes a bar code scanner that enables the customer to scan information from said bar code and include said information in said payment request.

16. The system of claim 10, wherein said request is transmitted from said customer device only upon input of a security code on said customer device.

17. The system of claim 16, wherein said customer device is a portable device from among a cellular phone, laptop computer, PDA, and Bluetooth enabled device.

18. The system of claim 1, wherein said wireless transmission operates via Bluetooth protocol, wherein implementation of said payment request creates a personal area network to complete the transaction.

19. A Bluetooth enabled system to authorize payment for personal transactions, said system comprising:
a first component having processing algorithm for securing authorization and payment for a transaction with a customer based on information received from a Bluetooth enabled device of said customer;
a second component associated with said first component that supports wireless communication via Bluetooth protocol;
means for receiving and responding to a request for payment for a transaction with a customer having said Bluetooth enabled device utilizing payment authorization data received from said Bluetooth enabled device; and
means for completing said transaction when authorization is secured, wherein payment for said transaction is received.

20. The system of claim 19, wherein said first component is a server.

21. The system of claim 20, wherein said server is connected to a wide area network which includes a verification mechanism for verifying payment information received from said Bluetooth enabled device and authorizing said payment.

22. The system of claim 19, wherein said second component is a vending machine, wherein further said system comprises means for providing a requested item from said vending machine in response to a completion of said financial transaction.

23. The system of claim 19, further comprising means for creating a personal area network with said Bluetooth enabled device and said first and second components.

24. The system of claim 23, wherein said second component includes memory, said system further comprising:
means for storing relevant customer identifying data received from said Bluetooth enabled device; and
means for completing future transactions without seeking authorization from said first component.

25. The system of claim 19, further comprising:
means by which said server communicates with a service provider with which said customer is affiliated and which is identified within said request to authorize and pay for said transaction; and
means for identifying an authorization of said transaction and transmitting notice of said authorization to said second component.

26. A method for authorizing payment for a transaction via a Bluetooth enabled device, said method comprising:
creating a personal area network (PAN) comprising a customer device, a billing terminal, and a background server, wherein at least said customer device and said billing terminal are interlinked via Bluetooth protocol; and
completing a customer's payment for a service or product received via said PAN, wherein a request for said payment is transmitted from said customer device and received at said background server, which initiates a process of securing authorization for said payment from a service provider with which said customer has a payment agreement.

27. The method of claim 26, wherein said creating step includes activating said customer device to communicate with said terminal.

28. The method of claim 27, wherein said activating step includes:
selecting a payment authorization option of said customer device; and
inputting a security code to enable generation of said payment request, wherein said payment request includes a customer identifier (ID) and an electronic address of said service provider.

29. The method of claim 27, wherein said request for said payment is transmitted directly to said terminal, which forwards said request to said server.

30. The method of claim 26, wherein said customer device has wireless phone communication capability and said creation of a PAN includes calling a phone number associated with said server to activate a creation of said Pan with said terminal.

31. The method of claim 26, wherein said customer device comprises a scanner by which a bar code may be read from a receipt generated by said transaction, said method comprising:
scanning said bar code; and
including transaction data from said bar code within said request.

32. The method of claim 26, wherein said customer device is one device from among a cellular phone, a PDA, a smart card, and a Bluetooth-specific device, wherein further said customer is configured to communicate according to Bluetooth protocol.
